(19) United States
(12) Patent Application Publication
(10) Pub. No.: US 2020/0179997 A1
(43) Pub. Date: Jun. 11, 2020

(54) SYSTEM AND METHOD FOR REMOVING EMERGING CONTAMINANTS FROM MATRICES

(71) Applicant: Arcadis U.S., Inc., Highlands Ranch, CO (US)

(72) Inventors: Ian Ross, Frodsham (GB); Jeffrey T. McDonough, Portland, ME (US); Jonathan Miles, Leeds (GB)

(73) Assignee: Arcadis U.S., Inc., Highlands Ranch, CO (US)

(21) Appl. No.: 16/707,104

(22) Filed: Dec. 9, 2019

Related U.S. Application Data
(60) Provisional application No. 62/776,598, filed on Dec. 7, 2018.

(51) Int. Cl. B09C 1/08; B09B 3/00; B01J 20/26

(52) U.S. Cl. CPC B09C 1/08; B01J 20/261; B09B 3/00

(57) ABSTRACT

A process for addressing the proliferation of emerging contaminants, such as PFASs, is provided. The process employs a fluoropolymer material that has characteristics that enhance its affinity to the emerging contaminants and, thus, draws the contaminants from a liquid or solid matrix in an efficient and economical way.

This application claims the benefit of U.S. Provisional Patent Application Ser. No. 62/776,598, filed Dec. 7, 2018, the entirety of which is incorporated by reference herein.

### FIELD OF THE INVENTION

Embodiments of the present invention are generally related to systems and methods for removing emerging contaminants from matrices using fluoropolymers, which comprise fluorinated macromolecules.

### BACKGROUND

There is an increasing demand in recent years to more efficiently remove emerging contaminants in many water bodies and soils, with drinking water supplies, surface waters, groundwater, soils, and sediments needing treatment globally to low compliance standards. Emerging contaminants, such as, for example, Poly- & Perfluoroalkyl Substances (PFASs), are chemicals that have been detected in global water supplies and soils at trace levels and for which the risks to human health is not yet fully known. They include around 5,000 differing individual compounds used for a very wide variety of commercial applications. Many people have been exposed to PFASs, and certain PFAS can accumulate and stay in the human body for long periods of time. Moreover, there are links between exposure to certain PFASs and adverse health outcomes in humans. There is presently no single system or method to selectively, safely, and efficiently remove, on an industrial scale, a wide range of PFASs from water bodies and soils that may eventually contribute the human health risks cited above. There is presently no system or method that provides a way to selectively remove fluorinated contaminants (such as PFASs) from impacted matrices (such as water bodies, soils, sediments, bio-solids and wastes) that provide more desirable binding sites for specific removal of halogenated chemicals such as PFASs, while also being regenerable.

It is with respect to the above issues and other problems presently faced by those of skill in the pertinent art that the embodiments presented herein were contemplated. Embodiments of the present invention solve the problems associated with the prior art and provides an apparatus and method that incorporates system and method for providing a regenerable alternative to conventional adsorptive technologies that has greater sorption potential and is selective for PFASs. Embodiments of the present invention use a differing adsorptive mechanism and novel material that has not been considered for use in PFASs treatment and is considered to be more efficient and cost effective than conventional adsorptive technologies. Other advantages and benefits will become apparent after reviewing the Summary and Detailed Description sections below.

### SUMMARY OF THE INVENTION

Accordingly, the present disclosure relates to systems and methods that overcome the problems identified above. While several advantages of the system and method of one embodiment are provided in this section, this Summary is neither intended nor should it be construed as being representative of the full extent and scope of embodiments of the present invention. Some embodiments of the present invention are set forth in various levels of detail in the Summary as well as in the attached drawings and in the Detailed Description, and no limitation as to the scope of this disclosure is intended by either the inclusion or non-inclusion of elements, components, etc. in the Summary. Additional aspects of the present disclosure will become more readily apparent from the materials included in the Detailed Description below.

In view of the shortcomings in the prior art, embodiments of the present invention solve the problems associated with the prior art and provides an apparatus and method that incorporates systems and methods for filtering emerging contaminants from a plurality of matrices via a regenerable fluorine rich solid material. The fluorine rich solid material can efficiently and selectively remove a plurality of highly fluorinated compounds, such as, for example, PFASs, from a plurality of organic compounds in multiple matrices, such as water supplies, groundwater, surface waters, soils, wastes and bio-solids, etc. Embodiments of the present invention comprise greater sorption potential than conventional adsorptive technologies such as, for example, activated carbon and ion exchange resins. Embodiments of the present disclosure are more selective for PFASs, are more commercially viable due to the low costs associated with powdered or granular fluoropolymers, and can be cost effectively scaled up for increased contaminant removal as compared to other systems and methods currently known in the art. Embodiments of the present invention also use a regenerable adsorptive mechanism via the use of one or more polymers or macromolecules that are fluorinated and, consequently, comprise a plurality of more desirable binding sites for fluorinated compounds, such as PFASs. Thus, embodiments of the present invention provide a more efficient and cost effective system for removing large-scale emerging contaminants by and through the fluorophillic properties of the one of more fluoropolymers. Thus, embodiments of the present invention provide a superior alternative to conventional adsorptive technologies.

Embodiments of the present invention also disclose a method for application of fluoropolymers (or fluorinated macromolecules) to be used in a filtration or sorptive capacity to selectively remove PFASs from impacted aqueous and solid matrices. A range of particle sizes that facilitate liquid flow through the granular or powdered fluoropolymer customized to a specific flow rate to achieve the designed contact time are applicable. The fluoropolymer may be installed within a conventional vessel sized to achieve the designed contact time in a parallel or series configuration within a conventional water treatment conveyance upstream or downstream or in place of other treatment components. The use of the fluoropolymer to remove PFASs from the aqueous phase may be supplemented with matrix specific adjustment of the ionic strength. After a duration of operation and treatment of liquid/aqueous matrices, the fluoropolymer may require regeneration informed by routine analytical testing downstream of the fluoropolymer vessel. In a series configuration, water conveyance would be temporarily discontinued to enable regeneration of the fluoropolymer. In a parallel configuration, water conveyance would be diverted to a secondary (backup) fluoropolymer vessel to enable isolation of the exhausted fluoropolymer vessel. Aqueous based regeneration would be achieved using a chemical reagent through a backflush operation. Embodiments of the present invention also disclose a method for application of a commercially available fluoropolymer to be used in a chemical stabilization capacity to fix PFASs associated with impacted solid matrices (e.g. sediments, soils and biosolids etc.). Using commercially available equipment, the granular or powdered fluoropolymer may be physically mixed into the impacted solid matrices to create contact between the fluoropolymer and the PFASs ensuring chemical stabilization. Stabilization may be enhanced by increasing the ionic strength of the aqueous phase as the soils are mixed with the fluoropolymer(s).

It is to be expressly understood that the ensuing description provides embodiments only, and is not intended to limit the scope, applicability, or configuration of the invention. Rather, this summary will provide those skilled in the art with an enabling description for implementing the embodiments. It should be understood that various changes may be made in the function and arrangement of elements without departing from the spirit and scope of the appended claims.

Furthermore, while embodiments of the present disclosure will be described in connection with various examples, it should be appreciated that embodiments of the present disclosure are not intended to be limited in any way.

While the invention is described in terms of exemplary embodiments, it should be appreciated that individual aspects of the invention may be separately claimed.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, serve to explain the principles of the disclosure.

FIG. 1 is an exemplar of the observed fluorophillicity, according to one embodiment of the present invention; and

FIG. 2 is an exemplar of the structural formulae of fluoropolymers/fluorinated macromolecules, according to an embodiment.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

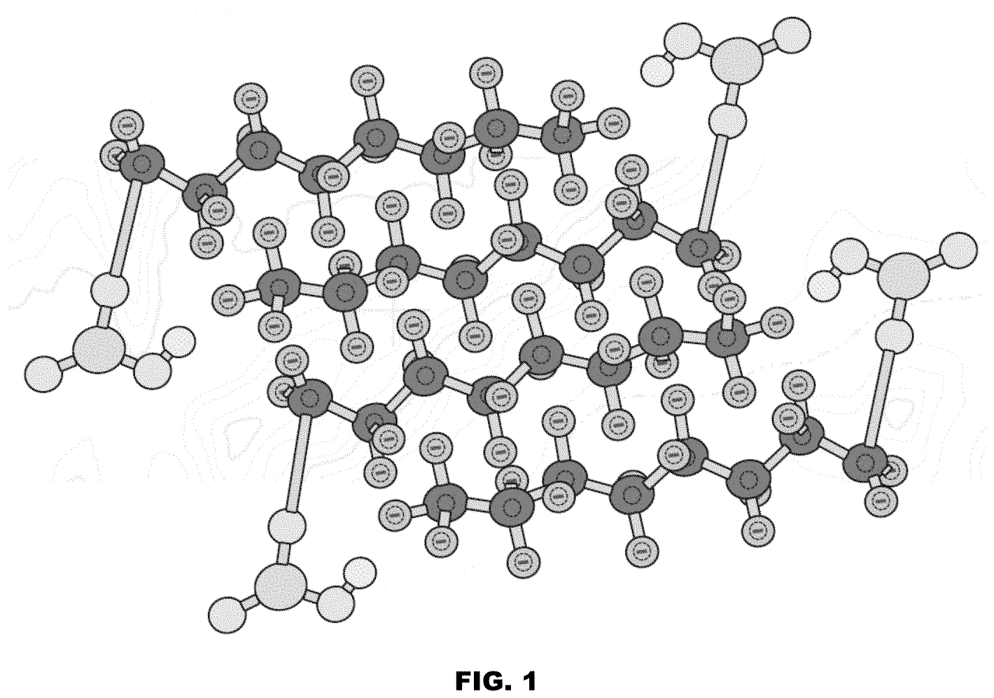

FIG. 1 describes the effect of fluorophillicity that in some embodiments removes or treats the halogenated chemicals such as PFASs in contaminated matrices using a fluorinated material such as a fluoropolymer (or commercially available fluorinated macromolecule), thus providing a more sorptive mechanism for selective removing the desired PFASs. The present system and method is also regenerable which provides a benefit over current adsorptive technologies currently used in the art. Moreover, embodiments of the present invention, as opposed to the prior art, do not require the initial step of adding a perfloroalky chain (or fluorinated ligand) to a solid support matrix. Rather, some embodiments comprise use of fluoropolymers such as, but not limited to, polytetrafluoroethylene (PTFE) also known as, Teflon, Fluon, Dyneon. In these embodiments, the desired PFAS containing matrices are easier to treat via filtration or chemical stabilization using the fluoropolymer (or fluorinated macromolecule based) materials. Moreover, these novel adsorptive media allow more effective and selective removal and treatment of PFASs from or in solid and liquid matrices such as water, soils, and/or complex wastes.

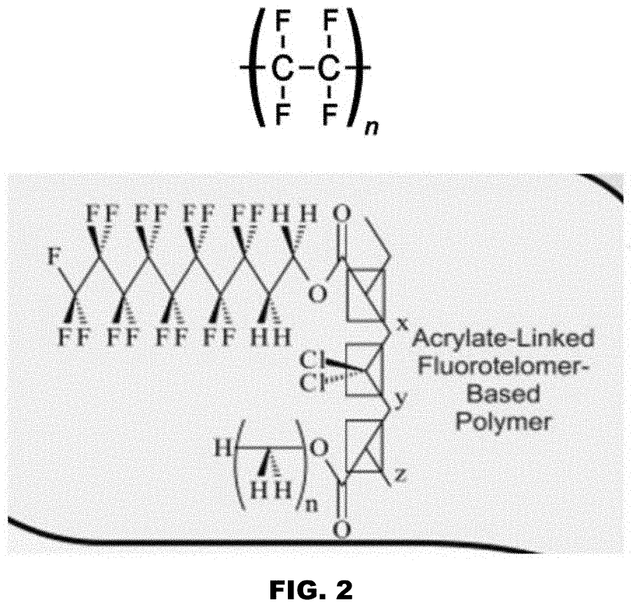

FIG. 2 depicts a fluoropolymer (bulk fluorinated chemical materials) according to one embodiment that comprises a plurality of desirable binding sites for halogenated chemicals, such as PFASs. Embodiments of the present invention are applicable to any PFAS impacted matrix including, but not limited to, municipal water, storm water, groundwater, surface water, landfill leachate, soils, sediments, biological solids (bio-solids), and process waste streams that requires efficient and optimized PFAS removal or binding to achieve low compliance levels in treated liquid or solid matrices.

The contemplated fluoropolymers of some embodiments provide a regenerable alternative to conventional adsorptive technologies currently used in the art, such as activated carbon and ion exchange resins. Embodiments of the present invention have greater sorption potential and are selective for PFASs. The present invention uses a differing adsorptive mechanism and novel material that has not been considered for use in PFASs treatment and is considered to be more efficient and cost effective than conventional adsorptive technologies.

In some embodiments, the media comprises fluorine rich solid materials such as, for example, several fluoropolymers (e.g. PTFE and side chain fluorotelomer methyl acrylates). As such, in these embodiments, the highly fluorinated adsorptive materials can selectively remove the fluorinated compounds such as PFASs from a mixture of organic compounds. These embodiments comprise a regenerable treatment option that has not been applied in PFASs treatment. A significant advantage of embodiments of the present invention are that the costs of powdered or granular fluoropolymers are very low (<$1/Kg) and they are readily available in large quantities, so they comprise a very cost effective treatment option. In some embodiments, the media may further comprise increased ionic strength via addition of dissolved ions (salts) to improve overall adsorptive removal and immobilization of PFASs.

Embodiments of the present invention further disclose a method of using the adsorptive media described herein, wherein \ a fluoropolymer (or fluorinated macromolecule) is used in a filtration capacity to selectively remove PFASs from impacted aqueous or liquid matrices. A range of particle sizes that facilitate flow through the particulate fluoropolymer customized to a specific flow rate to achieve the designed contact time are applicable. The fluoropolymer may be installed within a conventional vessel sized to achieve the designed contact time in a parallel or series configuration within a conventional water treatment conveyance upstream, downstream or in place of other treatment components. Removal or adsorption of emerging contaminants from various matrices using the fluoropolymer may be supplemented with matrix specific adjustment of the ionic strength. After a duration of operation and treatment of liquid/aqueous matrices, the fluoropolymer may require regeneration informed by routine analytical testing downstream of the fluoropolymer vessel. In a series configuration, water conveyance would be temporarily discontinued to enable a regeneration of the fluoropolymer. In a parallel configuration, water conveyance would be diverted to a secondary (back up) fluoropolymer vessel to enable isolation of the exhausted fluoropolymer vessel. Aqueous based regeneration would be achieved using a chemical reagent through a backflush operation. Embodiments of the present invention also disclose a method for application of a fluoropolymer to be used in a chemical stabilization capacity to fix PFASs associated with impacted solid matrices (e.g. sediments, soils and biosolids etc.). Using commercially available equipment, the granular or powdered fluoropolymer may be physically mixed into the impacted solid matrices to create contact between the fluoropolymer and the PFASs ensuring chemical stabilization.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A method of removing emerging contaminants from a matrix, comprising:
providing a fluorinated filtering material;
exposing the fluorinated filtering material to the matrix; and
adsorbing at least some of the emerging contaminants from the matrix.

2. The method of claim 1, wherein the fluorinated filtering material is polytetrafluoroethylene and wherein the emerging contaminants comprise one or more types of poly- and perfluoroalkyl substances.

3. The method of claim 1, wherein the matrix is comprised of liquid that is fed into a vessel that contains the fluorinated filtering material, wherein fluid flow exiting the vessel is analyzed to assess the amount of emerging contaminants in the fluid exiting the vessel, and further comprising regenerating the fluorinated filtering material using a chemical reagent when the amount of emerging contaminants found in the fluid exiting the vessel is in an amount above a predetermined level.

4. The method of claim 1, wherein the ionic strength of the fluorinated filtering material is selectively modified to suite the characteristics of the matrix.

5. The method of claim 1, wherein the matrix is comprised of impacted soil, wherein a perfloroalky chain is not added to the impacted soil.
